(19) United States
(12) Patent Application Publication
(10) Pub. No.: US 2007/0128937 A1
(43) Pub. Date: Jun. 7, 2007

(54) EMI shroud with placement stops

(76) Inventors: Jerry A. Long, Elgin, IL (US); Kent E. Regnier, Lombard, IL (US)

Correspondence Address: MOLEX INCORPORATED, 2222 WELLINGTON COURT, LISLE, IL, 60532, US

(21) Appl. No.: 11/633,937

(22) Filed: Dec. 4, 2006

Related U.S. Application Data
(60) Provisional application No. 60/742,588, filed on Dec. 6, 2005.

(51) Int. Cl. H01R 13/648

(52) U.S. Cl. 439/607

(57) ABSTRACT

An EMI gasket takes the form of a formed conductive shroud that completely encircles a metal shielding cage. The shroud has an opening that is surrounded by a plurality of sides and all of the sides contain slots that receive spring contacts of a metal shielding cage. The slots contain shoulders to limit the travel of the spring contacts within the shroud slots and thereby limit the travel of the shroud on the shielding cage.

### BACKGROUND OF THE INVENTION

The present invention relates generally to structures that prevent or retard electromagnetic interference (“EMI”) emissions from connector assemblies, and more particularly to an EMI shroud intended for use on a metal shielding cage for blocking electromagnetic interference emissions.

It is a common practice in the electronic arts to connect cables to a circuit board by utilizing plug connectors at the ends of the cables which are intended for insertion into an opposing mating connector. The mating connector is typically mounted on a circuit board, which is held within an exterior housing. Such an arrangement is typically found in servers and routers. These devices have multiple connector assemblies that now operate at high speeds, typically 2 gigabits per second and greater. The high speed electrical transmission in these devices can produce electromagnetic emissions, which may leak from the connection between the plug connector and its mating connector. These emissions can cause problems in high speed transmissions in that they can negatively influence signal transmissions between the connectors.

These types of transmissions are routinely reduced by the use of a metal shielding cage that is also mounted to the circuit board and which surrounds the mating connector in the device. These cages have openings that open to a faceplate, which is commonly referred to as a bezel in the art. These openings define an entrance leading toward the mating connector into which the plug connector is inserted. Testing has determined that despite the metal shielding cages, EMI leakage still occurs in such structures, primarily at the areas where the shielding cages meet the circuit board and around the opening(s) of the faceplate or bezel, into which the cage openings extend. Conductive gaskets have been developed in efforts to address this problem.

Problems still exist in the use of gaskets, for it is desired that the gaskets be conductive and held in close contact to both the shielding cages and the faceplate. These cages are becoming smaller and smaller in size as the overall size of most electronic devices continues to diminish. The small size of the cages often makes it difficult to develop a structure that will force the EMI gasket into reliable contact with the faceplate and the cage, without detrimentally affecting the strength of the shielding cage.

Accordingly, the present invention is directed to an improved EMI gasket structure that takes the form of a shroud with a movement limiting means integrated therewith, and which overcomes the disadvantages of the prior art.

Examples of prior approaches proposed for addressing EMI shielding problems include U.S. Pat. No. 5,204,496 (Boulay, et al.) and No. 6,420,009 (Cheng) that show incorporating a bent flange EMI gasket. U.S. Pat. No. 6,851,978 (Akama, et al.) proposes a hook for a shielding cage gasket. Included in U.S. Pat. No. 6,752,663 (Bright, et al.) is a shielding gasket assembly having pre-formed slots that fit over and receive mounting feet of the bottom of a cage. The combination of a formed gasket and a backing plate is shown in U.S. Pat. No. 6,878,872 (Lloyd, et al.). These patents, and all other references noted herein, are hereby incorporated hereinto by reference.

### SUMMARY OF THE INVENTION

Accordingly, it is a general object of the present invention to provide an EMI gasket structure for use with a shielding cage that utilizes a conductive shroud and a means for fixing the shroud on the shielding cage.

Another object of the present invention is to provide an EMI gasket assembly in the form of a flexible shroud that encircles the opening of a metal shielding cage, the shroud closely fitting against the cage and an interior surface of a faceplate installed over the cage opening, the assembly including means for fixing the position of the shroud on the shielding cage so that it will contact with the faceplate interior surface when the faceplate is applied over the front end of the shielding cage.

A still further object of the present invention is to provide a biased EMI gasket for a metal shielding cage, the shielding cage having a generally rectangular front end that fits into an opening of a faceplate of an electronic device, the front end including a plurality of grounding spring arms formed therewith at preselected locations on the perimeter of the shielding cage front end, the gasket including a conductive shroud that encircles the cage front end, the shroud including a plurality of slots, each slot receiving one of the grounding spring arms therein, the shroud slots including stops that engage the grounding spring arms to locate the shroud in a preselected position upon the shielding cage front end.

The present invention accomplishes these and other objects and aspects by virtue of its structure, which in one principle aspect includes a conductive shroud that has a generally rectangular shape, so that it extends around the perimeter of the front end of the shielding cage. Preferably, the shroud is formed from a single piece of conductive material, such as a metal-coated plastic or a moldable composition that includes a conductive additive, and it is formed with a central opening so that it extends in a continuous fashion around the entire perimeter of the shielding cage front end.

The shroud as exemplified by the preferred embodiment of the invention, may be formed with a plurality of slots disposed on its inner surface and extending around the opening. Each of these slots is positioned to receive a single grounding spring member that is formed in the exterior surfaces of the shielding cage. These slots have associated shoulders disposed therein that provide stop surfaces in the shroud. The free ends of the grounding spring members contact these shoulders and limit the movement of the shroud on the shielding cage in one direction.

These and other objects, features and advantages of the present invention will be clearly understood through a consideration of the following detailed description.

### BRIEF DESCRIPTION OF THE DRAWINGS

The invention, together with its objects and the advantage thereof, may be best understood by reference to the following description taken in conjunction with the accompanying drawings, in which like reference numerals identify like elements in the figures and in which:

FIG. 1 is a perspective view of an electronics assembly that utilizes a shielding cage, an internal connector mounted to a circuit board and an EMI gasket constructed in accordance with the principles of the present invention;

FIG. 2 is a perspective view, take from the rear of FIG. 1, but illustrated in an exploded fashion with the EMI gasket and faceplate removed from the shielding cage front end;

FIG. 3 is a perspective view of the EMI gasket of FIG. 1 removed from the shielding cage;

FIG. 4 is an enlarged detail view of the EMI gasket in place upon the shielding cage and illustrating how the slots thereof receive the spring contacts of the shielding cage;

FIG. 5 is a sectional view of the EMI gasket in place upon the shielding cage showing the internal stop shoulders of the EMI gasket in contact with the free ends of the contact springs of the shielding cage; and,

FIG. 6 is a partial sectional view showing gasket-spring finger interaction.

### DETAILED DESCRIPTION OF THE PREFERRED EMBODIMENTS

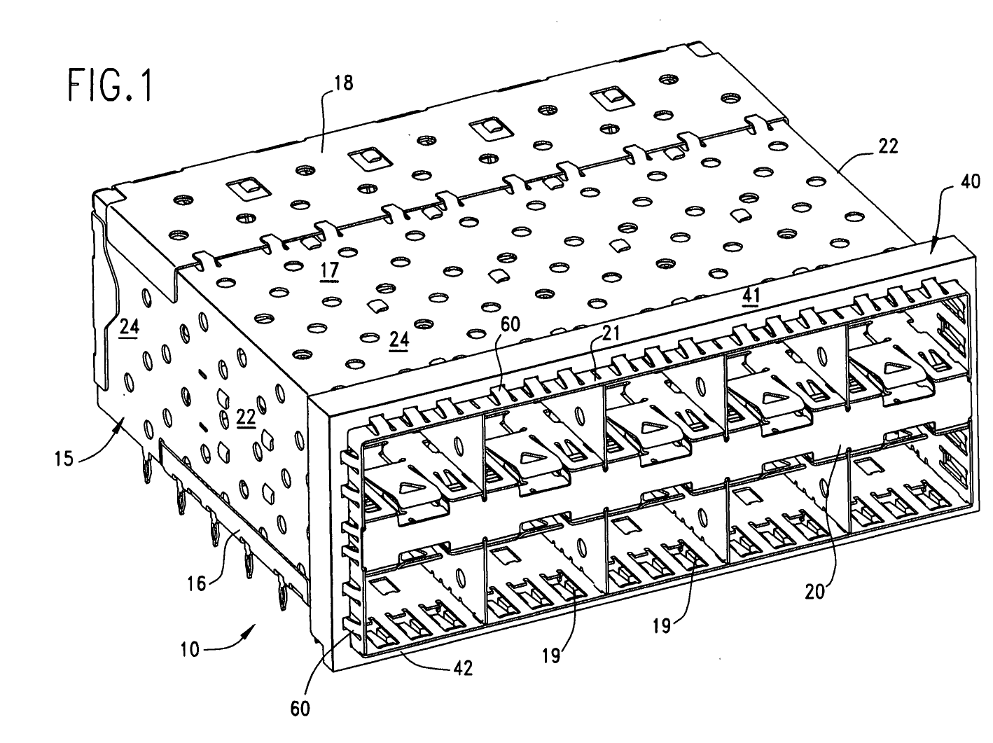

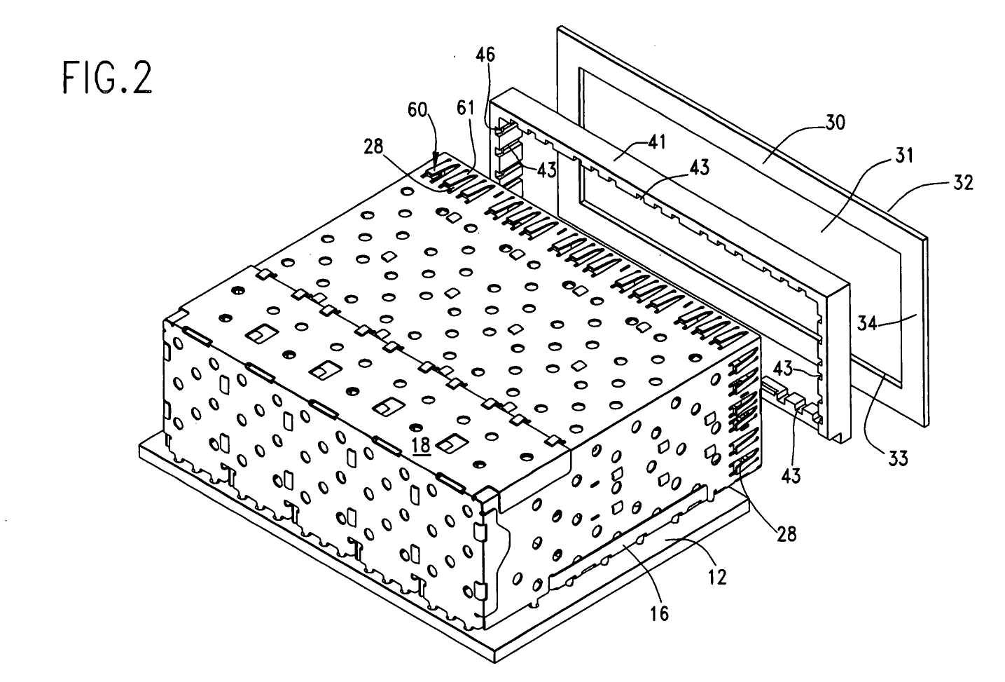

FIG. 1 illustrates an electronic assembly 10 of the type that would normally be found in a router or server and which is utilized in the transmission of high speed data signals. Such an assembly includes a plurality of receptacle-style connectors (not shown) that are mounted in a stacked configuration, to a circuit board 12 (FIG. 2). A metal shielding cage 15 is provided and as shown the cage 15 includes a base plate, or bottom wall 16, a body portion 17 (which includes a pair of spaced apart sidewalls 22) and a rear and top plate, or wall, 18 that engages the cage and covers its rear end and part of its top. The cage 15 has a series of openings 19 that lead to respective hollow interior bays, into each of which an electronic module (also not shown) attached to a cable end, may be inserted. Once assembled, the shielding cage 15 has a plurality of exterior surfaces 24. The metal shielding cage 15 is conductive and the front end of it is usually inserted into a faceplate of an electronic device. Specifically, the front end 21 of the shielding cage assembly is received within an opening 31 of the faceplate 30 (FIG. 2).

FIG. 1 shows the assembly as including a shielding cage 15 of the 2×5 style, that is two horizontal rows with five cage openings 19 each extending in a horizontal fashion. The openings 19 are stacked one on top of each another and in order to accommodate this arrangement, the shielding cage 15 illustrated includes an interior, or center, wall portion 20 which separates the two bays or openings from each other. Electronic modules, which are connected to wire cables, are inserted into and removed from the cage openings in order to make a connection to the receptacle connectors held in the interior of the shielding cage 15.

The shielding cage 15 and its internal connectors and supporting circuit board are held together in an exterior enclosure (not shown) but which includes a faceplate, or bezel 30 (FIG. 2). This faceplate 30 sits over the front of the exterior enclosure and around the perimeter of the shielding cage as shown. In this regard, the faceplate 30 is typically a continuous member, formed from sheet metal with a desired thickness, and an inner opening 31. A lip 33 defines the inner surface of the faceplate opening and the faceplate has a front, or outer, surface 32 and a rear, or inner, surface 34. The front end 21 of the shielding cage projects slightly past the outer surface 31 of the faceplate 30. The fit between the shielding cage front end 21 and the faceplate lip 33 is preferably an interference fit, with the faceplate loose enough to be slid over the cage front end 21.

The area between the faceplate and the shielding cage is prone to the discharge, or leakage, of electromagnetic emissions during high speed data transfer that can cause EMI. Accordingly, designers in the electronic arts endeavor to provide some sort of gasket that fits between the shielding cage and the faceplate. The present invention is directed to such a gasket of an improved type and to a shielding cage assembly incorporating same. It is desirable that an EMI gasket for such devices that is located between the cage and the faceplate be held in contact with both the cage and the faceplate. Achieving uniform contact that addresses leaking of electromagnetic emissions is problematic.

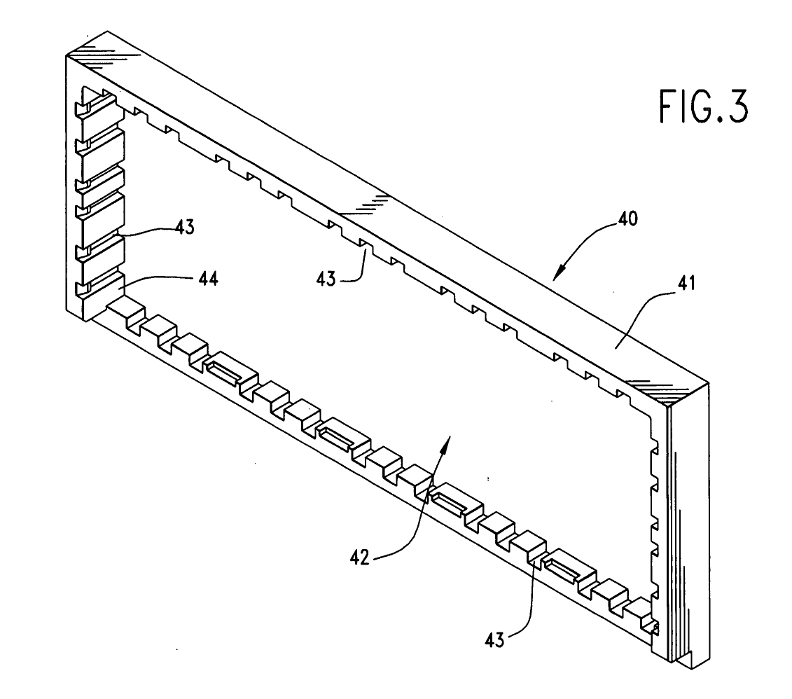

The present invention utilizes an improved gasket construction. As shown in FIGS. 1 and 3 a conductive gasket 40 is provided in the form of a conductive shroud 41. The shroud 41 includes a plurality of sides, which are preferably interconnected together to form a continuous structure. The shroud 41 has an opening 42 formed therein that is sized to receive the front end 21 of the shielding cage therein. The shroud 41, in the embodiment shown, and particularly as illustrated in FIG. 3, is formed from a plastic material that may be coated with metal plating on its exterior surfaces. Other materials may include plastics with conductive material impregnated therewith or conductive sintered or die-cast materials. The shroud may be made of a rigid conductive material or a pliable or flexible material, such as one exhibiting a degree of elasticity, to provide a biased EMI gasket.

The shroud 41 can be seen to include a plurality of slots, or channels 43 that are spaced apart from each other along the inner surface 44 of the shroud 41. These channels 43 are shown as extending completely through the shroud from its front edge to its rear edge. The channels 43 may include stop surfaces in the form of raised shoulders 46 that are disposed in a transverse direction to the extent of the slots 43. The raised shoulders 46 are shown in the slots of the sidewall, but it will be understood that these shoulders 46 may be utilized in the slots on the top and bottom sides of the shroud, as well.

Irrespective of the location or locations from which the stop surfaces or shoulders 46 protrude, they are provided in order to engage ends of the cage spring fingers or contacts as described herein. Stops or shoulders 46 limit the extent to which the gasket can be pushed back upon the cage.

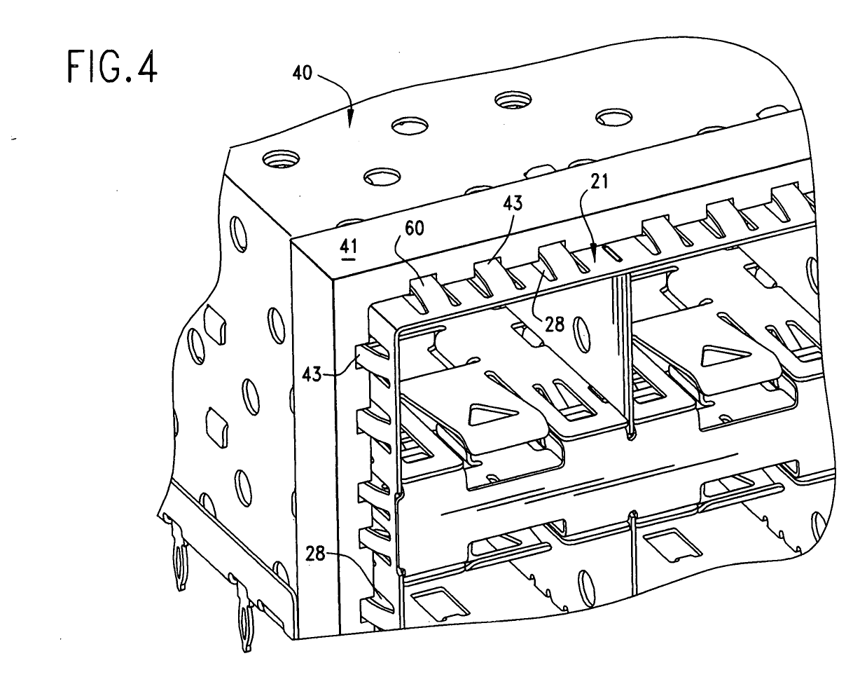

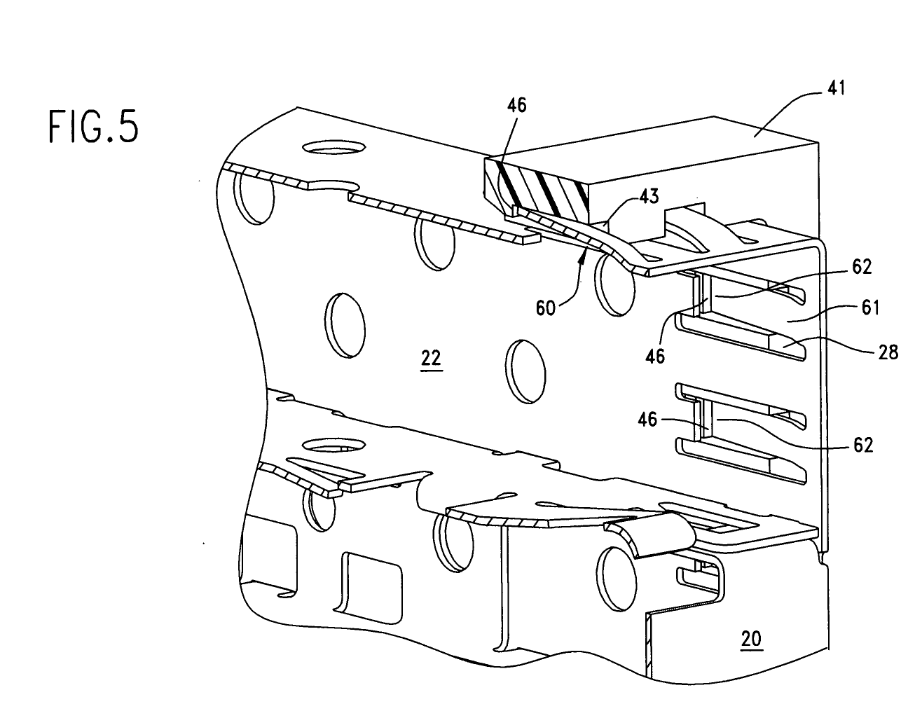

With particular reference to FIGS. 4, 5 and 6, these shoulders 46 serve as stop surfaces for a series of spring contacts 60 in the form of arms that extend away from the shielding cage and which are disposed in a spaced-apart fashion along the perimeter of the front end 19 of the shielding cage 15. The illustrated spring contacts 60 are defined by a series of U- or H-shaped slots 28 that are formed in the body of the cage front end 21. These slots 28 serve to define the basic shape of the spring contacts 60. Each such contact 60 may be considered as having a base portion 61 that is joined to the cage, and a free end 62 that extends away from the cage, and shown in the drawings in a direction away from the front openings 19 of the cage and toward the rear end of the shielding cage 15. These members are bent slightly upwardly and as such, they act as springs, which can deflect downwardly but exert a force upwardly or outwardly. The contact springs 60 are received in the shroud slots 43 and the contact spring free ends 62 abut against the shoulders 46 in the slots 43.

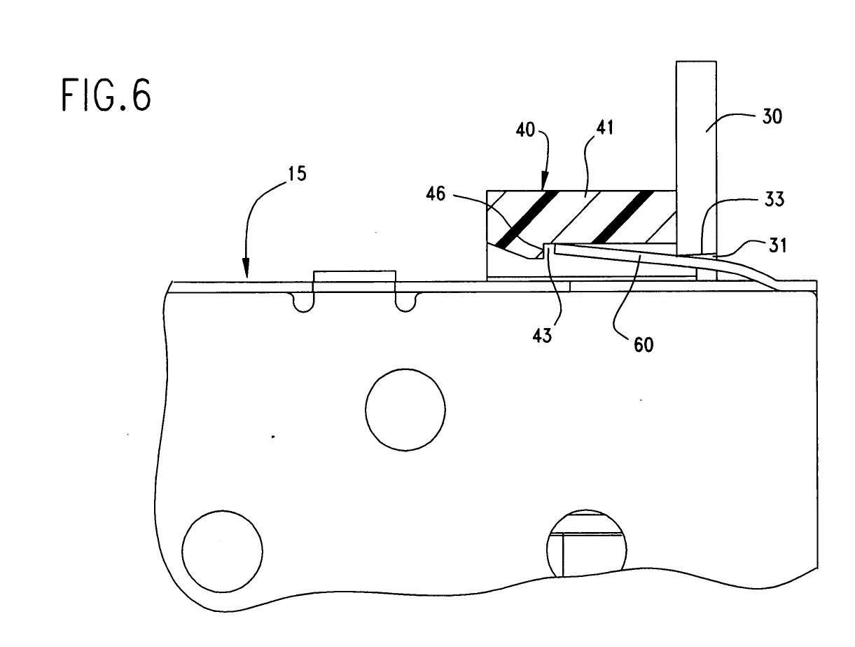

FIG. 6 illustrates a particular embodiment of a shoulder portion 46 shown in position for engagement with the free end of the illustrated contact 60. Thus, with the interaction provided by this combination, once the shroud 41 is slid over the faceplate 30, the shoulder portion or stop 46 is in position to engage the contact spring to facilitate maintaining the shroud in place.

In this manner, the shroud 41 may be placed over the front end 21 of the shielding cage 15 and moved rearwardly (such as to the left in FIG. 6) thereon until the contact spring free ends 62 contact the stops or shoulders 46. This sets the forwardmost position of the shroud 41 on the shielding cage 15 and prevents the shroud from deviating in its movement during assembly of the shielding cage 15 into the electronic device. The spring contacts also exert a radially outwardly directed force on the shroud slots, and this force is sufficient to retain it in place on the shielding cage.

While the preferred embodiment of the invention have been shown and described, it will be apparent to those skilled in the art that changes and modifications may be made therein without departing from the spirit of the invention, the scope of which is defined by the appended claims.

1. A shielding cage assembly for housing a connector mounted to a circuit board in an electronic device, the assembly comprising:
a metal shielding cage having at least top and bottom walls and a pair of spaced apart sidewalls that cooperate with the top and bottom walls to define an enclosure for housing the connector, the shielding cage including a front end with at least one opening disposed thereat which leads to an interior portion of said shielding cage, the front end being received within an opening of a faceplate of the electronic device, said front end including a plurality of raised spring contacts extending away therefrom; and,
an EMI gasket for reducing EMI emissions between said shielding cage and said faceplate opening, the gasket including a conductive shroud that fits around said shielding cage front end, the shroud including a central opening that receives said shielding cage front end therein, said shroud including an inner perimeter with a plurality of slots, the slots receiving the shielding cage spring contacts therein when said shroud is placed over said shielding cage front end.

2. The shielding cage assembly of claim 1, wherein said shroud is a continuous member.

3. The shielding cage assembly of claim 1, wherein said shielding cage includes at least one vertical and at least one horizontal interior wall, the horizontal and vertical walls intersecting to divide said shielding cage opening into at least two distinct sub-openings.

4. The shielding cage assembly of claim 1, wherein said shroud is formed from a plastic and is coated with a metal composition.

5. The shielding cage assembly of claim 1, wherein said shroud is formed from a conductive plastic.

6. The shielding cage assembly of claim 1, wherein said spring contacts include free ends and base portions joined to said shielding cage, the free ends being received with said shroud slots.

7. The shielding cage assembly of claim 6, wherein said shroud slots include shoulder portions that engage said spring contact free ends in a manner so as to limit movement of said shroud upon said shielding cage.

8. The shielding cage assembly of claim 7, wherein said shoulders are disposed in said shroud slots only along two opposing sides of said shroud.

9. The shielding cage assembly of claim 6, wherein said shielding cage includes a plurality of U-shaped slots that define the perimeter of said spring contacts.

10. A shielding cage assembly for housing a connector mounted to a circuit board in an electronic device, the assembly comprising:
a metal shielding cage having at least top and bottom walls and a pair of spaced apart sidewalls that cooperate with the top and bottom walls to define an enclosure for housing the connector, the shielding cage including a front end with at least one opening disposed thereat which leads to an interior portion of said shielding cage, the front end being received within an opening of a faceplate of the electronic device, said front end including a plurality of raised spring contacts extending away therefrom; and,
an EMI gasket for reducing EMI emissions between said shielding cage and said faceplate opening, the gasket including a conductive shroud that fits around said shielding cage front end, the shroud including a central opening that receives said shielding cage front end therein, said shroud including an inner perimeter with a plurality of slots having shoulder portions, the slots receiving the shielding cage spring contacts therein and said spring contacts engage said shoulder portions when said shroud is placed over said shielding cage front end.

11. The shielding cage assembly of claim 10, wherein said shroud is a continuous member.

12. The shielding cage assembly of claim 10, wherein said shielding cage includes at least one vertical and at least one horizontal interior wall, the horizontal and vertical walls intersecting to divide said shielding cage opening into at least two distinct sub-openings.

13. The shielding cage assembly of claim 10, wherein said shroud is formed from a plastic and is coated with a metal composition.

14. The shielding cage assembly of claim 10, wherein said shroud is formed from a conductive plastic.

15. The shielding cage assembly of claim 10, wherein said shroud slot shoulder portions engage said spring contact in a manner so as to limit movement of said shroud upon said shielding cage.

16. The shielding cage assembly of claim 10, wherein said shoulders are disposed only in said shroud slots only along two opposing sides of said shroud.

17. An EMI gasket for a shielding cage, the gasket comprising:
a conductive shroud, the shroud having a plurality of sides interconnected to each other and an opening disposed therein, the opening being sized and shaped to receive a shielding cage therein, said shroud including an inner perimeter with a plurality of slot positional transverse to said inner perimeter, the slots receiving a plurality of spring contacts of said shielding cage therein when said shroud is placed over a front end of a shielding cage.

18. The EMI gasket of claim 17, wherein at least one of said slots includes a stop within the slot, and said stop engages a shielding cage spring contact when the EMI gasket is placed over a shielding cage.

19. The EMI gasket of claim 17, wherein said shroud is a continuous member.

20. The EMI gasket of claim 17, wherein said shroud is formed from a conductive plastic or from a plastic coated with a metal composition.
